(19) United States
(12) Patent Application Publication
(10) Pub. No.: US 2026/0179272 A1
(43) Pub. Date: Jun. 25, 2026

(54) MANAGING VIRTUAL BACKGROUND IMAGE LIGHTING FOR REALISTIC VIDEO COMMUNICATION SESSIONS

(71) Applicant: MOTOROLA MOBILITY LLC, WILMINGTON, DE (US)

(72) Inventors: AMIT KUMAR AGRAWAL, BANGALORE (IN); RAHUL Bharat DESAI, Hoffman Estates, IL (US)

(21) Appl. No.: 18/999,801

(22) Filed: Dec. 23, 2024

(51) Int. Cl. G06T 11/00; H04N 7/15

(52) U.S. Cl. CPC G06T 11/10; H04N 7/15

(57) ABSTRACT

An electronic device provides a more realistic composite video feed for a video communication session by triggering a change to a virtual background image that is illuminated from a direction closely aligned with a direction of illumination of a user. A processor is configured to cause the electronic device to detect a virtual background setting, receive a video stream from an image capturing device positioned to capture the user during the video communication session, and determine a beam direction of a lighting source illuminating the user in the video stream. The processor identifies a virtual background image presenting a background illuminated from a direction that closely aligns with the beam direction of the lighting source illuminating the user. The processor causes the electronic device to generate, present, and transmit a composite video feed including a foreground image of the video stream superimposed on the virtual background image with correct lighting.

### BACKGROUND

### 1. Technical Field

The present disclosure relates generally to electronic devices that support person-to-person(s) communication, and more particularly to electronic devices that support real-time person-to-person video communication.

### 2. Description of the Related Art

Electronic communication devices such as smartphones, tablets, laptops and desktop workstations enable users to participate in person-to-person(s) communication. To better emulate an in-person communication session, the electronic device may be configured to share a video of a corresponding user via a communication network to other second electronic device(s) to present to corresponding second user(s). Although the user may choose to share his image, in many instances the user may not want to reveal an actual image of what is visible around the user. In an example, the user may prefer to present a more professional decor or to make an individual statement with a selection of a virtual background image. Video conferencing modules that facilitate the video communication session enable extracting a user image that is superimposed onto the selected virtual background image for presenting on the electronic device and second electronic device(s).

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices, according to one or more embodiments;

FIG. 2 illustrates a further block diagram of the electronic device configured to trigger selection of a virtual background image that is illuminated from a direction that is closely aligned with a direction from which a user is illuminated to create a more realistic composite video feed, according to one or more embodiments;

FIG. 3 illustrates an unrealistic first composite video with a user image illuminated from the right side superimposed on a first virtual background image illuminated from the left side according to one or more embodiments;

FIG. 4 illustrates a realistic second composite video with the user image illuminated from the right side superimposed on a second virtual background image also illuminated from the right side, according to one or more embodiments;

FIG. 5 illustrates an unrealistic third composite video with the user image illuminated from the right side superimposed on a third background image illuminated from the left side, according to one or more embodiments;

FIG. 6 illustrates a realistic fourth composite video with the user image illuminated from the right side superimposed on a version of the third background image horizontally mirrored to also be illuminated from the right side, according to one or more embodiments;

FIG. 7 illustrates a display of the electronic device presenting a virtual background selection window as part of a video communication setup user interface, according to one or more embodiments;

FIG. 8A illustrates a display of the electronic device presenting a video communication session window with an unrealistic first composite video feed of a user image and a virtual background selection window recommending a change in a virtual background image, according to one or more embodiments;

FIG. 8B illustrates the display of the electronic device presenting the video communication session window with a realistic composite video after a selection of the recommended virtual background image, according to one or more embodiments;

FIG. 9 is a flow diagram presenting a computer-implement method for triggering a change to a virtual background image illuminated from a direction closely aligned with a direction of illumination of a user image, according to one or more embodiments; and

FIGS. 10A-10B (collectively “FIG. 10”) are a flow diagram presenting a computer-implement method that augments the method of FIG. 9 for soliciting and implementing user input, via a user interface, in selecting virtual background images with realistic direction of lighting, according to one or more embodiments.

### DETAILED DESCRIPTION

According to aspects of the present disclosure, an electronic device, a method and a computer program provide various techniques for presenting a more realistic composite video feed by triggering a change to a virtual background image illuminated from a direction closely aligned with a direction of illumination of a user. Usage of video communication has become common-place and is used in all industries. In the corporate world, use of video communications provides significant savings on travel costs and time for in-person meetings, while providing a more connected experience compared to phone calls, even for one-on-one situations. Often, users prefer to set a predefined image as their background to mask their actual background and to present a professional appearance that is realistic. However, when the composite video is presented, the illusion of a realistic composite video is defeated when a direction of lighting of the virtual background image does not match a direction of lighting of the device user. The background thus appears to be artificial. Aspects of the present disclosure overcomes this mismatched lighting scenario by triggering a change of the virtual background image to one that has lighting direction closely aligned with the lighting direction of the user.

In one or more embodiments, the electronic device, method, and computer program product manage background images for users on a video call. The electronic device determines that the user is participating in a video conferencing session facilitated by a video communication application. The electronic device detects whether the user prefers to keep the camera turned on during the video conferencing application. Before the start of any video call or during a video communication session, the electronic device reviews all of the background image options and determines the apparent source of light by measuring the dynamic range of each photo. The electronic device indexes each background image to indicate the location of the light. In an example, locations of the light source can include upper left, top, upper right, right, lower right, bottom, lower left, front, back, and center. The electronic device prompts the user to change his or her background if the actual light source of the room differs from the simulated light source of the selected virtual background image. In one or more embodiments, in response to an alternate virtual background setting, rather than prompting the user to change, the electronic device automatically changes the background to one in which the lighting source matches the actual lighting source of the room.

According to one or more embodiments, an electronic device has a memory including a video communication application (VCA) having a plurality of virtual background images. Each virtual background image is illuminated by a light source from a respective one of a plurality of different directions. The electronic device includes a communications subsystem that links the electronic device to a communication network. A processor of the electronic device is communicatively coupled to the memory and the communications subsystem. The processor executes the VCA to enable a video communication session between the electronic device and one or more second electronic device. The processor is further configured to cause the electronic device to detect a virtual background setting of the VCA for the video communication session. In response, the processor is further configured to cause the electronic device to receive a video stream from an image capturing device positioned to capture a user of the electronic device during the video communication session. The processor is further configured to cause the electronic device to determine a beam direction of a lighting source illuminating the user in the video stream. The processor is further configured to cause the electronic device to identify a first virtual background image presenting a background illuminated from a first direction that closely aligns with the beam direction of the lighting source illuminating the user. The processor is further configured to cause the electronic device to generate and present a composite video feed including a foreground image of the video stream superimposed on the first virtual background image. The composite video feed is used for transmission to the one or more second electronic devices during the video communication session.

According to one or more embodiments, a method provides a more realistic composite video feed by triggering a change to a virtual background image illuminated from a direction closely aligned with a direction of illumination of the device user. The method may include detecting a virtual background setting of the VCA including a plurality of virtual background images. Each virtual background image is illuminated by a light source from a respective one of a plurality of different directions. The method may include receiving a video stream from an image capturing device positioned to capture a user of an electronic device during a video communication session. The method may include determining a beam direction of a lighting source illuminating the user in the video stream and identifying a first virtual background image presenting a background illuminated from a first direction that closely aligns with the beam direction of the lighting source illuminating the user. The method may include generating and presenting a composite video feed comprising a foreground image of the video stream superimposed on the first virtual background image, the composite video feed for transmission to one or more second electronic devices during a video communication session.

Further embodiments provide a computer program product that includes: a non-transitory computer readable medium; and program code on the computer readable medium that, when processed by a processor of an electronic device, configures the processor and/or the electronic device to perform functions of the above-described method.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent within the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized, and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

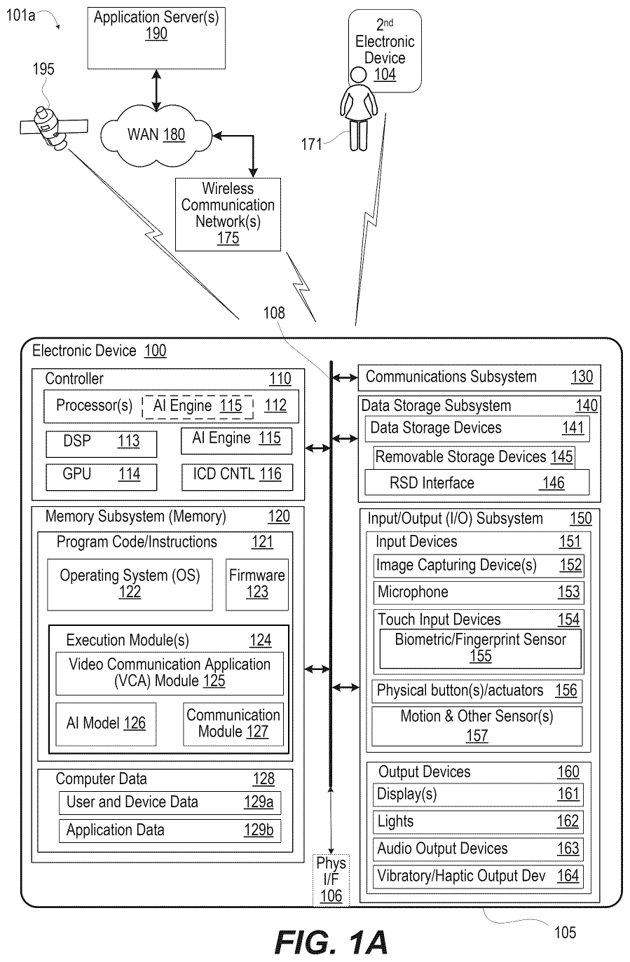

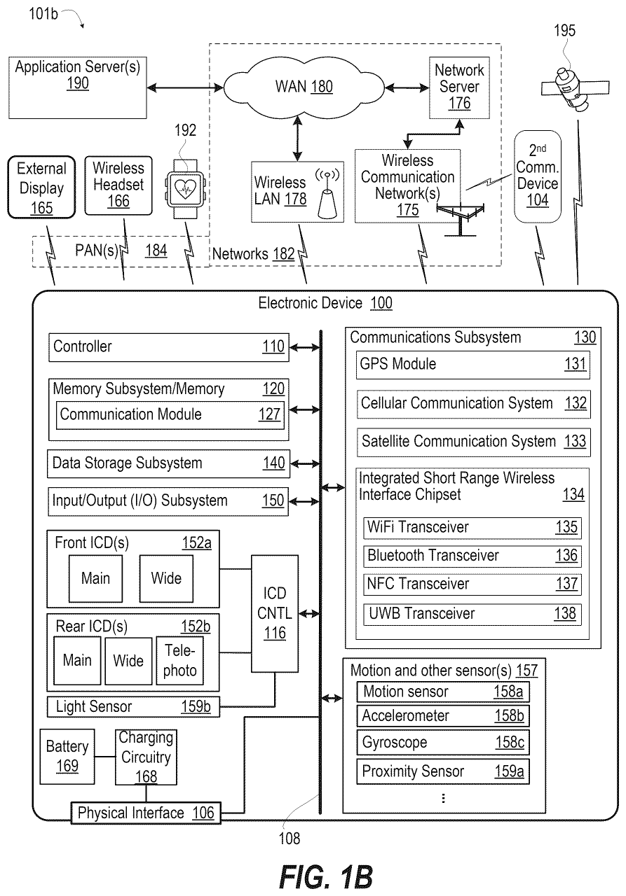

Those of ordinary skill in the art will appreciate that the hardware components and basic configuration depicted in the following figures may vary. For example, the illustrative components within electronic device 100 (FIG. 1A-1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, operational, or otherwise) on the described embodiments.

Referring now to the figures and beginning with FIG. 1A, there is illustrated a block diagram of an example electronic device 100 in communication environment 101a and having hardware and software components, which enable the features of the present disclosure to be advantageously implemented, according to one or more embodiments. Electronic device 100 provides implements various techniques for providing a more realistic composite video feed by triggering a change to a virtual background image illuminated from a direction closely aligned with a direction of illumination of a user. Examples of electronic device 100 can include, but are not limited to, mobile devices, a notebook computer, a mobile phone, a smart phone, a digital camera with enhanced processing capabilities, a smart watch, a tablet computer, and other types of electronic devices. For purposes of this disclosure, electronic device is assumed to be a communication device that can be used to engage in a voice and/or video call with a second communication device. Electronic device 100 can therefore be interchangeably referred to herein as communication device 100.

Electronic device 100 generally includes controller 110, memory (or memory subsystem) 120, communication subsystem 130, data storage subsystem 140, input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more of operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113, graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown). Processor 112 can further include other processors such as auxiliary processor(s) that may act as a low power consumption, always-on sensor hub for physical sensors.

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122.

Memory subsystem (or memory) 120 may include a combination of volatile and non-volatile memory, such as random-access memory (RAM) and read-only memory (ROM). Memory subsystem 120 stores instruction or program code 121 for execution by processor 112 to configure processor 112 (and more generally electronic device 100) to provide the operational functions and features described herein. Instructions/program code 121 (or program code 121 for short) includes instructions for an operating system (OS) 122, firmware 123, such as basic input/output system (BIOS) or Uniform Extensible Firmware Interface (UEFI). Program code 121 includes execution module(s) 124 that collectively provides the various features of the disclosure. Execution module(s) 124 include, without limitation, video communication application (VCA) module 125, which provides the features and operating functionality of the disclosed embodiments when the corresponding program instructions of VCA module 125 are processed by/within processor 112/controller 110.

Execution modules 124 further includes AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within VCA module 125 and is trained to support the AI features of VCA module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, VCA module 125 can include program instructions that cause or configure processor 112 to cause electronic device 100 to trigger selection of a more realistically illuminated virtual background image for a video communication session. Other features provided by VCA module 125 are described in further detail throughout this disclosure.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 104 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of VCA module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons/actuators 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detect movement of electronic device 100 and provide motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile, touch screen interface (154) can be utilized as an input device. The touch screen interface (154) can include one or more virtual buttons or selectable affordances. In one or more embodiments, when a user applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located on a rear surface of device housing 105. Other embodiments provide multiple integrated displays within electronic device 100 and references to display(s) 161 are assumed to refer to one or all of these multiple integrated displays.

Vibration/haptic output device 164 can cause electronic device 100 to vibrate or shake when activated. Vibration/haptic output device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101b. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101b that includes other devices.

Communications subsystem 130 includes global positioning system (GPS) module 131 that enables electronic device to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a Wi-Fi router of a wireless local area network (WLAN) 178 and/or second electronic device 104, via one or more short-range wireless interface(s). Second electronic device 104 can be a communication device, such as a smartphone, and/or can be similarly configured as electronic device 100. Second user 171 may operate second electronic device 104. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of VCA module 125 and/or access to other applications, online transactions, and resources. In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 192. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 192, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as an input/output data port and can be used as a power supply port that is coupled to charging circuitry 168 which feeds electrical power to device battery 169 to enable recharging of device battery 169 and/or powering of electronic device 100. As a data port, physical interface 106 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICD(s) can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image or iris scan recognition.

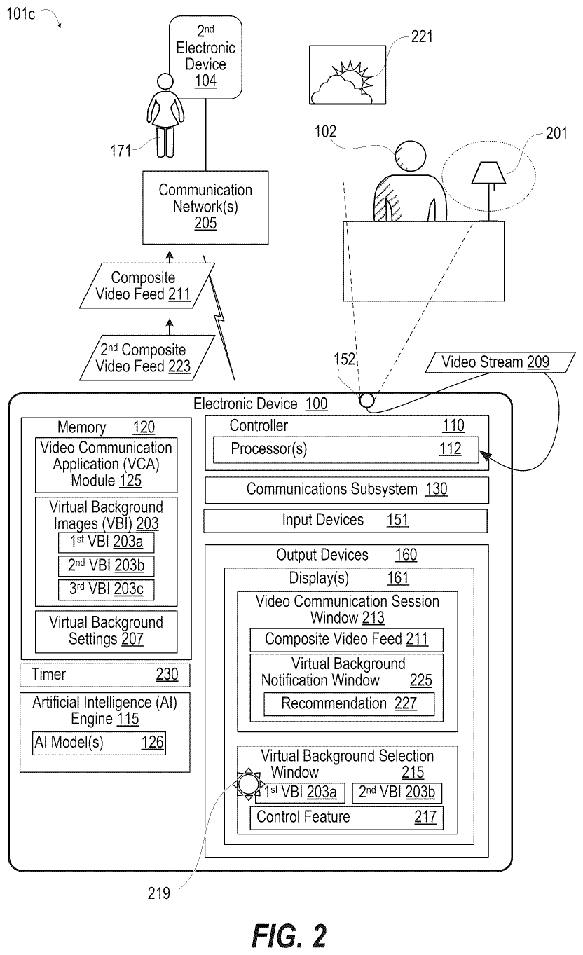

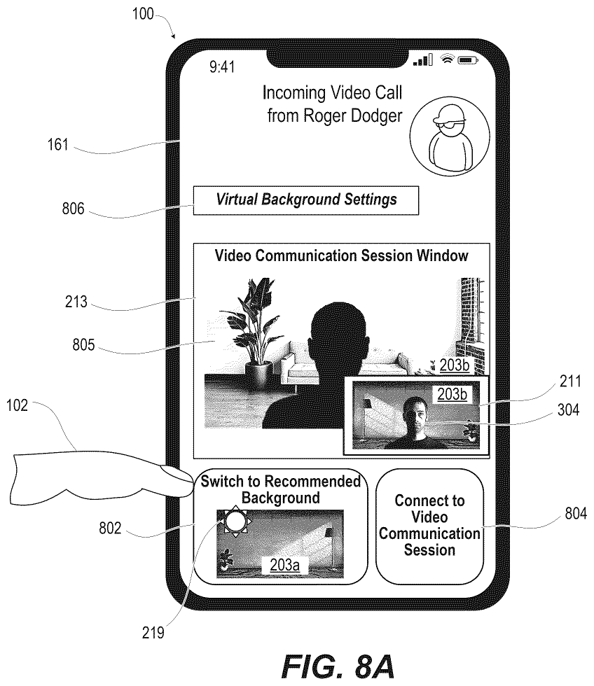

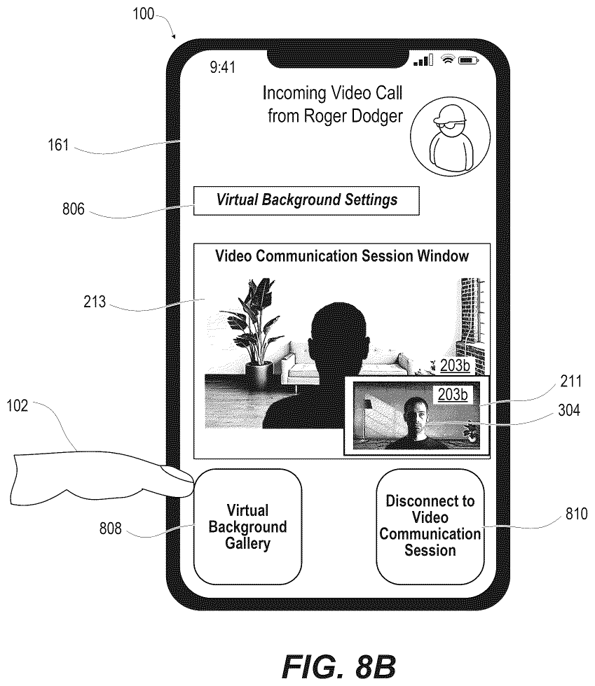

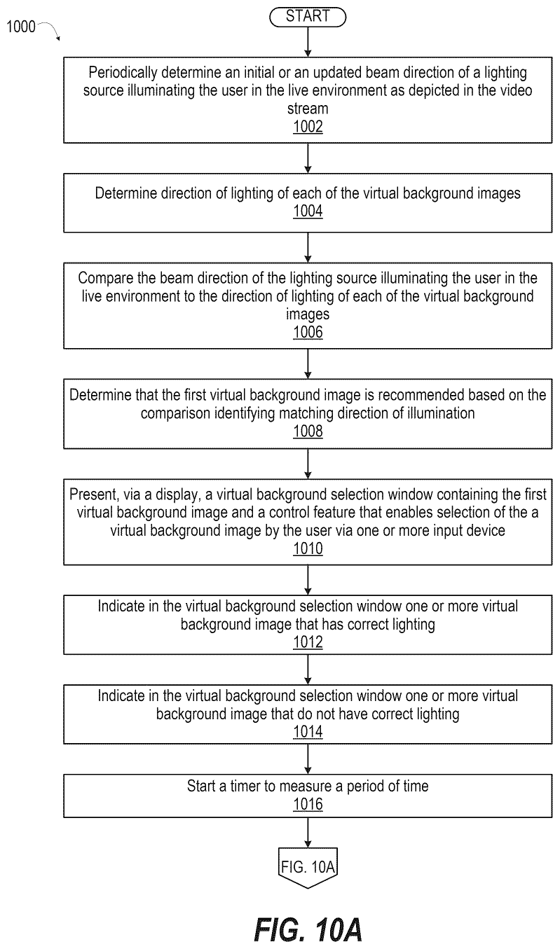

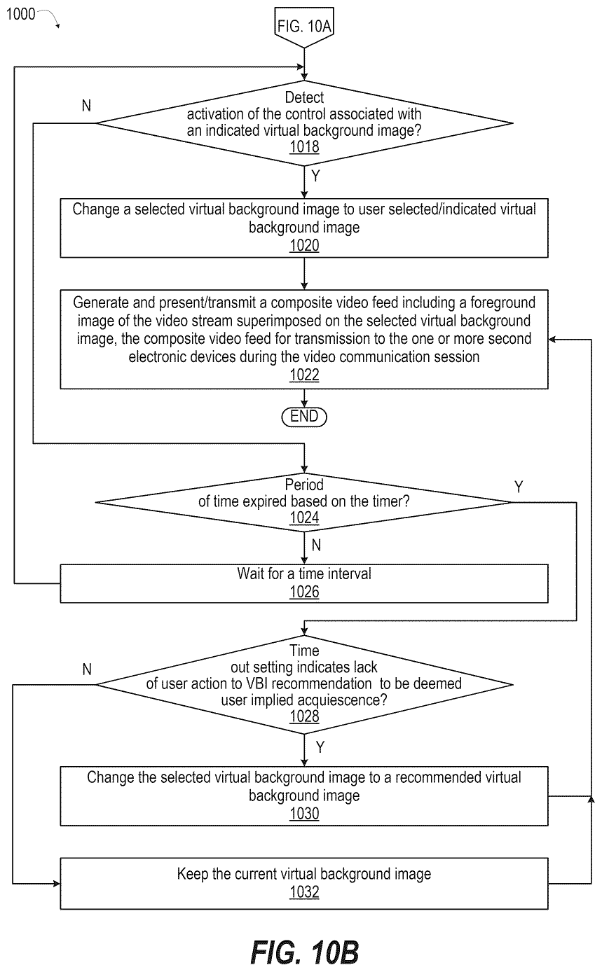

FIG. 2 illustrates a further block diagram of communication environment 101c with electronic device 100 configured to trigger selection of a virtual background image that is illuminated from a direction that is closely aligned with a direction from which user 102 is illuminated by light source 201 to create a more realistic composite video feed 211. According to aspects of the present disclosure, electronic device 100 has memory 120 including VCA module 125 having a plurality of virtual background images (VBIs) 203. Each virtual background image (e.g., first VBI 203a and second VBI 203b) is illuminated by a light source from a respective one of a plurality of different directions. Electronic device 100 includes communications subsystem 130 that links electronic device 100 to communication network(s) 205 (e.g., wireless communication network(s) 175 of FIG. 1A or networks 182 of FIG. 1B). Processor 112 (FIG. 1A) is communicatively coupled to memory 120 and communications subsystem 130. Processor 112 executes VCA module 125 to enable a video communication session between electronic device 100 and one or more second electronic device 104. Processor 112 is further configured to cause electronic device 100 to detect virtual background settings 207 of VCA module 125 for the video communication session. Processor 112 is further configured to cause electronic device 100 to receive video stream 209 from image capturing device 152 positioned to capture user 102 of electronic device 100 during the video communication session. Processor 112 is further configured to cause electronic device 100 to determine a beam direction of lighting source 201 illuminating user 102 in video stream 209. Processor 112 is further configured to cause electronic device 100 to identify first VBI 203a presenting a background illuminated from a first direction that closely aligns with the beam direction of lighting source 201 illuminating user 102. Processor 112 is further configured to cause electronic device 100 to generate and present composite video feed 211 including a foreground image (i.e., user image) of video stream 209 superimposed on first VBI 203a. Composite video feed 211 is provided for transmission to one or more second electronic devices 104 during the video communication session. In one or more embodiments, to generate composite video feed 211, processor 112 is configured to cause electronic device 100 to extract a video image of user 102 from video stream 209. Processor 112 is configured to cause electronic device 100 to overlay the video image of user 102 on first VBI 203a. Electronic device 100 may include one or more timer 230 used for virtual background image selections, such as described below with regard to FIG. 8A and FIG. 10A.

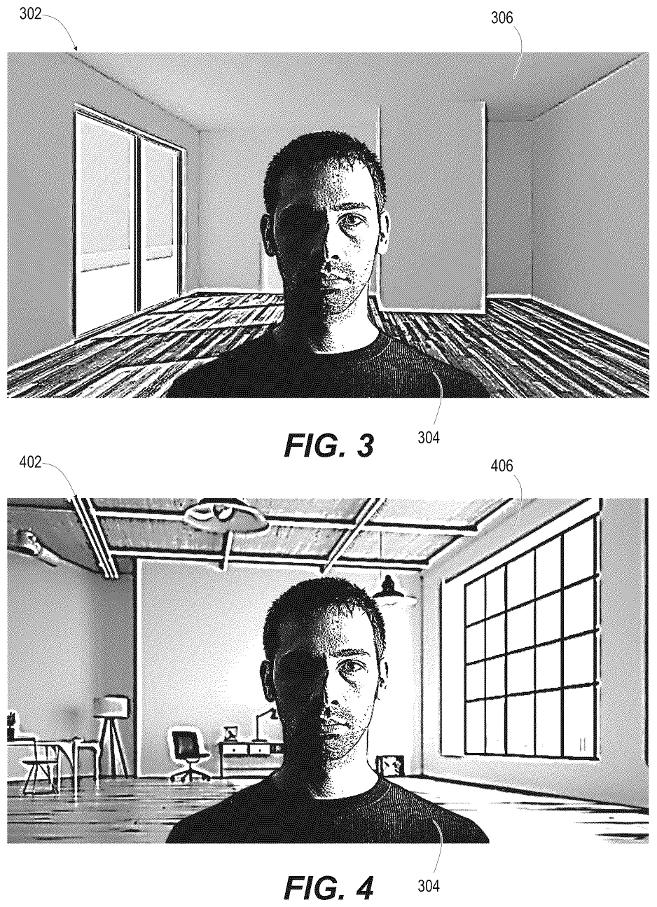

FIG. 3 illustrates an example of unrealistic composite video feed 302 with user image 304 illuminated as viewed from the right side, presented on third virtual background image 306 illuminated as viewed from the left side. By contrast, FIG. 4 illustrates realistic second composite video feed 402 with user image 304 illuminated from the right side, presented on second virtual background image 406 which is also illuminated from the right side.

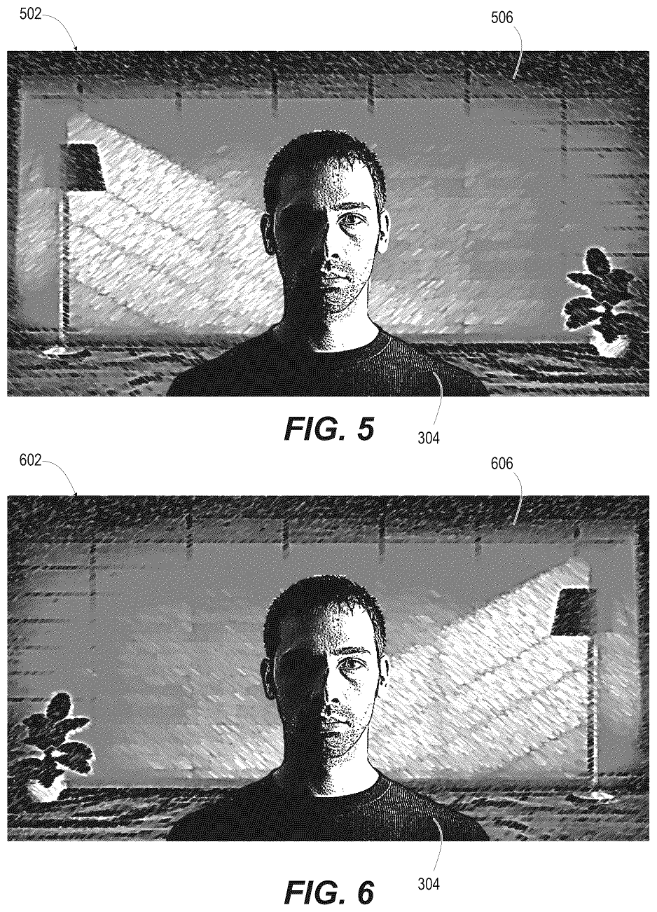

In another example, FIG. 5 illustrates unrealistic third composite video 502 with user image 304 illuminated from the right side superimposed on third background image 506 which is illuminated from the left side. To provide an alternative virtual background image that is more realistic, the electronic device 100 can search for or generate a version of the same background image that has matching orientation of lighting with user image 304. FIG. 6 illustrates realistic fourth composite video 602 with user image 304 illuminated from the right side superimposed on fourth virtual background image 606, which is a version of third background image 506 (FIG. 5) horizontally mirrored to also be illuminated from the right side.

With continued reference to FIG. 2, in one or more embodiments, processor 112 is configured to cause electronic device 100 to generate and render, via display 161 of output device(s) 160, video communication session window 213 that includes one of first composite video feed 211 or second composite video feed 223. In one or more embodiments, processor 112 is configured to cause electronic device 100 to transmit, via communications subsystem 130, composite video feed 211 to one or more second electronic devices 104, which are configured to generate and render, via respective second displays, a video communication session window containing one of first composite video feed 211 or second composite video feed 223.

In one or more embodiments, processor 112 is configured to cause electronic device 100 to present, via display 161, virtual background selection user interface (UI) window 215 containing first VBI 203a and control feature 217 that enables selection of first VBI 203a by user 102 via one or more input device 151. In one or more particular embodiments, in presenting, via display 161, virtual background selection UI window 215 containing first VBI 203a and control feature 217, processor 112 is configured to cause electronic device 100 to indicate in virtual background selection UI window 215 that first VBI 203a has correct lighting (e.g., annotation 219). Processor 112 is configured to cause electronic device 100 to indicate in virtual background selection UI window 215 that second VBI 203b does not have correct lighting (e.g., no annotation).

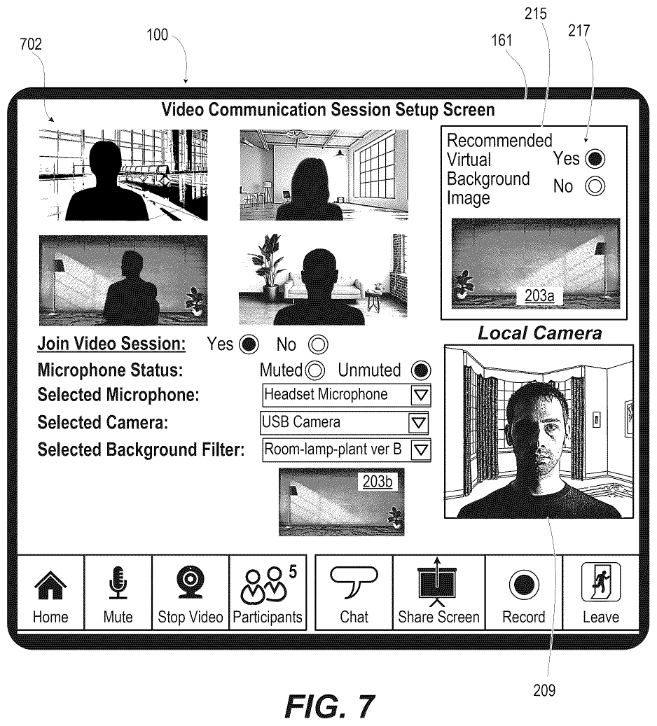

FIG. 7 illustrates an example display 161 of electronic device 100 presenting virtual background selection UI window 215 as part of video communication setup window 702. In an example, virtual background selection UI window 215 contains first virtual background image 203a and control feature 217 that enables selection of first VBI 203a by user 102.

With continuing reference to FIG. 2, in one or more embodiments, processor 112 is configured to cause electronic device 100 to periodically determine an updated beam direction of lighting source illuminating user in video stream 209. In response to determining that the updated beam direction has changed from the first direction to a third direction, processor 112 is configured to cause electronic device 100 to identify third VBI 203c of VBIs 203 presenting a background illuminated from a direction that closely aligns with the third beam direction of a second lighting source 221 illuminating user 102. Processor 112 is configured to cause electronic device 100 to generate and present second composite video feed 223 including a foreground image of video stream 209 superimposed on third VBI 203c. Second composite video feed 223 is provided for transmission to one or more second electronic devices 104 during the video communication session.

In one or more embodiments, in response to determining that a currently selected virtual background image 203 is not first VBI 203a, processor 112 is configured to cause electronic device 100 to generate and render virtual background notification window 225 containing recommendation 227 for user 102 to select first VBI 203a. In an example, virtual background selection UI window 215 is presented before entering a video communication session or when a full setup interface is selected by user 102. Virtual background notification window 225 may be a popup window that surfaces during the video communication session. In one or more particular embodiments, in response to determining that a change in selection of a currently selected virtual background image 203 has not occurred within a period of time tracked by timer 230 following presentation of recommendation 227, processor 112 is configured to cause electronic device 100 to change the currently selected virtual background image 203 to the first VBI 203a.

FIG. 8A illustrates display 161 of electronic device 100 presenting example virtual background selection UI window 215 recommending a change (within recommendation segment 802) in a selected virtual background image 203 (FIG. 2). Video communication session window 213 may be visible before triggering control 804 to connect/join a video communication session, showing composite video feed 805 that is being received from second communication device 104 (FIG. 2) along with a currently selected first composite video feed 211. Selected first composite video feed 211 will be transmitted if the user proceeds to join the communication session without a change in VBI 203. First composite video feed 211 is an unrealistic composite video of user 102 with second VBI 203b. Alternatively, video communication session window 213 may not be visible until the video communication session is connected/joined. Virtual background settings control 806 allows user to go to a more detailed setup screen, such as depicted and described with regard to FIG. 7. The user may interact with the detailed settings before joining or during the video communication session. In some situations, video communication session window 213 is presented during the video communication session. The user may trigger presentation of detailed settings. Alternatively, the electronic device may automatically present detailed settings when a need to change VBI 203 is detected. In some instances, such as an incoming call, user 102 may prefer an expedited selection of a virtual background image 203 (FIG. 2), such as just accepting recommendation 227 for first VBI 203a immediately followed by selecting control 804 to connect to the video communication session. As a first alternative to explicit acceptance accepting recommendation 227, electronic device 100 may automatically recommended virtual background image 203. As a second alternative to explicit acceptance or automatic acceptance, electronic device 100 may determine acquiescence to the change based on expiration of a period of time tracked by timer 230 since presenting a recommended virtual background image 203.

FIG. 8B illustrates display 161 of electronic device 100 presenting video communication session window 213 with realistic second composite video feed 223 of user image 304 superimposed on first virtual background image 203a after explicit user selection, automatic selection, or acquiescence to selection of the recommendation. Virtual background gallery control 808 allows the user to select a different virtual background image, each of which are respectively annotated as recommended or not. Disconnect control 810 facilitates ending or leaving the video communication session.

With continuing reference to FIG. 2, in one or more embodiments, electronic device 100 includes artificial intelligence (AI) engine 115. Processor 112 is configured to cause electronic device 100 to determine a lighting direction of one of a virtual background image 203 and of user 102 in video stream 209 by using AI engine 115 trained to determine a lighting direction of an image. In one or more embodiments, the plurality of virtual background images 203 includes first VBI 203a and at least one second VBI 203b that is a structurally identical background image to first virtual background image and has a different light source direction from among the plurality of different directions.

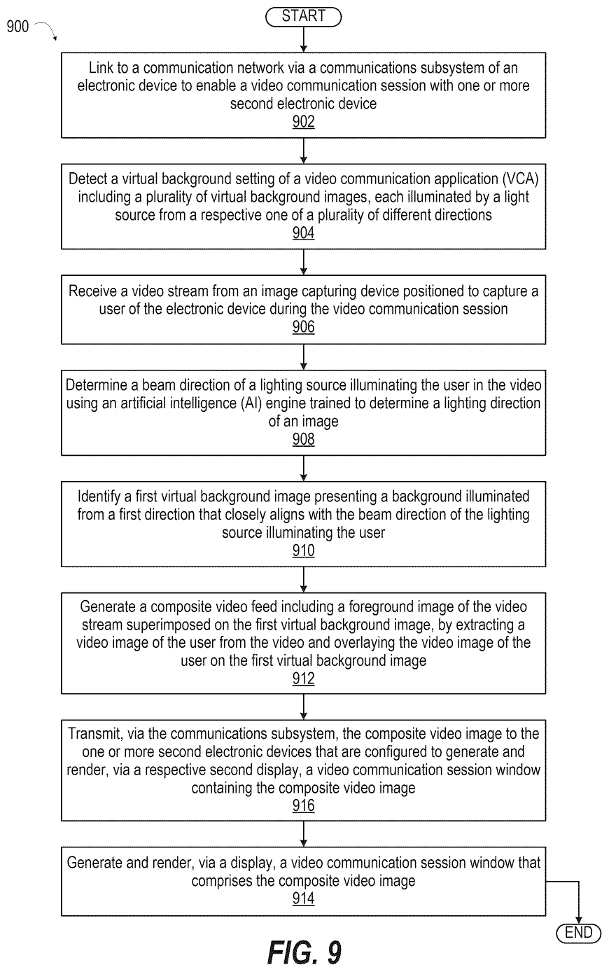

FIG. 9 is a flow diagram presenting computer-implement method 900 for triggering a change to a virtual background image illuminated from a direction closely aligned with a direction of illumination of user image. FIGS. 10A-10B (collectively “FIG. 10”) are a flow diagram presenting a computer-implement method that augments method 900 of FIG. 9 for soliciting and implementing user input, via a user interface, in selected virtual background images with realistic direction of lighting. The descriptions of method 900 (FIG. 9) and method 1000 (FIG. 10) are provided with general reference to the specific components illustrated within the preceding FIGS. 1A-1B, 2-7 and 8A-8B . Specific components referenced in method 900 (FIG. 9) and method 1000 (FIG. 10) may be identical or similar to components of the same name used in describing preceding FIGS. 1A-1B, 2-7 and 8A-8B . In one or more embodiments, controller 110 (FIG. 1A) configures electronic device 100 (FIGS. 1A-1B) or a similar computing device to provide the described functionality of method 900 (FIG. 9) and method 1000 (FIG. 10).

With reference to FIG. 9, method 900 optionally includes linking to a communication network via a communications subsystem of an electronic device to enable a video communication session with one or more second electronic device (block 902). Method 900 includes detecting a virtual background setting of a video communication application (VCA) including a plurality of virtual background images, each illuminated by a light source from a respective one of a plurality of different directions (block 904). In one or more embodiments, the plurality of virtual background images include a first virtual background image and a second virtual background image, where both are based on a structurally identical background image respectively illuminated by the light source from the respective one of the plurality of different directions. In one or more embodiments, a first and a second virtual background image do not include a structurally identical background image. Method 900 includes receiving a video stream from an image capturing device positioned to capture a user of the electronic device during the video communication session (block 906). Method 900 includes determining a beam direction of a lighting source illuminating the user in the video using an artificial intelligence (AI) engine trained to determine a lighting direction of an image (block 908). Method 900 includes identifying a first virtual background image presenting a background illuminated from a first direction that closely aligns with the beam direction of the lighting source illuminating the user (block 910).

In one or more embodiments, as depicted in FIG. 9, method 900 may automatically change a virtual background image to provide a realistic lighting of a user. In an example, a setting of VCA module 125 (FIG. 1A) may enable automatic selection and use of an appropriate virtual background image. A currently selected virtual background image may be part of a set of virtual background images having the same structurally identical background with selectable versions illuminated from different beam directions. In one or more embodiments, method 900 may include informing a user of virtual background images that do and do not have correct lighting to match lighting of the user, enabling the user to make an informed selection of a virtual background image that appears more realistic. An example of informing a user of virtual background images that do and do not have correct lighting to match lighting of the user is described below with regard to method 1000 of FIG. 10.

With continued reference to FIG. 9, method 900 includes generating a composite video feed including a foreground image of the video stream superimposed on the first virtual background image, by extracting a video image of the user from the video and overlaying the video image of the user on the first virtual background image (block 912). Method 900 includes generating and rendering, via a display, a video communication session window that comprises the composite video feed (block 914). Method 900 includes transmitting, via the communications subsystem, the composite video feed to the one or more second electronic devices that are configured to generate and render, via a respective second display, a video communication session window containing the composite video feed (block 916). Then method 900 ends.

According to aspects of the present disclosure, method 900 of FIG. 9 may include linking to a communication network via a communications subsystem of an electronic device to enable a video communication session with one or more second electronic device. Method 900 includes detecting a virtual background setting of a video communication application (VCA) comprising a plurality of virtual background images, each illuminated by a light source from a respective one of a plurality of different directions. Method 900 includes receiving a video stream from an image capturing device positioned to capture a user of the electronic device during the video communication session. Method 900 includes determining a beam direction of a lighting source illuminating the user in the video. Method 900 includes identifying a first virtual background image presenting a background illuminated from a first direction that closely aligns with the beam direction of the lighting source illuminating the user. Method 900 includes generating and presenting a composite video feed comprising a foreground image of the video stream superimposed on the first virtual background image, the composite video feed for transmission to the one or more second electronic devices during the video communication session.

In one or more embodiments, method 900 may include generating the composite video feed by extracting a video image of the user from the video and overlaying the video image of the user on the first virtual background image. Method 900 may include generating and rendering, via a display, a video communication session window that comprises the composite video feed. Method 900 may include transmitting, via the communications subsystem, the composite video feed to the one or more second electronic devices that are configured to generate and render, via a respective second display, a video communication session window containing the composite video feed.

In one or more embodiments, method 900 may include presenting, via a display, a virtual background selection window containing the first virtual background image and a control feature that enables selection of the first virtual background image by the user via one or more input device. In one or more particular embodiments, method 900 may include indicating in the virtual background selection window that the first virtual background image has correct lighting. Method 900 may include indicating in the virtual background selection window that the second virtual background image does not have correct lighting.

In one or more embodiments, method 900 may include periodically determining an updated beam direction of a lighting source illuminating the user in the video. Method 900 may include, in response to determining that the updated beam direction has changed from the first direction to a third direction, identifying a third virtual background image presenting a background illuminated from a direction that closely aligns with the third beam direction of the lighting source illuminating the user. Method 900 may include generating and presenting a composite video feed comprising a foreground image of the video stream superimposed on the third virtual background image, the composite video feed for transmission to the one or more second electronic devices during the video communication session.

In one or more embodiments, in response to determining that a currently selected virtual background image is not the first virtual background image, method 900 may include generating and rendering a virtual background notification window containing a recommendation for the user to select the first virtual background image. In response to determining that a change in selection of a currently selected virtual background image has not occurred within a period of time following presentation of the recommendation, method 900 may include changing the currently selected virtual background image to the first virtual background image.

In one or more embodiments, method 900 may include determining a lighting direction of one of a background image and of the user in the video feed by using an artificial intelligence (AI) engine trained to determine a lighting direction of an image.

In one or more embodiments, method 900 may include periodically determining an updated beam direction of a lighting source illuminating the user in the video stream. In response to determining that the updated beam direction has changed from the first direction to a third direction, method 900 may include identifying a third virtual background image presenting a background illuminated from a direction that closely aligns with the third beam direction of the lighting source illuminating the user. Method 900 may include generating and presenting a second composite video feed comprising a foreground image of the video stream superimposed on the third virtual background image, the composite video feed for transmission to the one or more second electronic devices during the video communication session.

Turning now to FIG. 10A, method 1000 may include periodically determining an initial or an updated beam direction of a lighting source illuminating the user in the live environment as depicted in the video steam (block 1002). Method 1000 may include determining direction of lighting of each of the virtual background images (block 1004). Method 1000 may include comparing the beam direction of the lighting source illuminating the user in the live environment to the direction of lighting of each of the virtual background images (block 1006). Method 1000 may include determining that the first virtual background image is recommended based on the comparison identifying matching direction of illumination (block 1008). Method 1000 may include presenting, via a display, a virtual background selection window containing the first virtual background image and a control feature that enables selection of a virtual background image by the user via one or more input device (block 1010). Method 1000 may include indicating in the virtual background selection window one or more virtual background image that has correct lighting (block 1012). Method 1000 may include indicating in the virtual background selection window one or more virtual background image that do not have correct lighting (block 1014). Method 1000 may include starting a timer to measure a period of time (block 1016). Then method 1000 proceeds to block 1018 of FIG. 10B.

With reference to FIG. 10B, method 1000 includes determining whether activation is detected of the control at the one or more input device associated with a recommended virtual background image (decision block 1018). In response to determining that activation is detected of the control at the one or more input device associated with a recommended virtual background image, method 1000 includes changing a selected virtual background image to user selected/indicated virtual background image (block 1020). Method 1000 includes generating and presenting/transmitting a composite video feed including a foreground image of the video stream superimposed on the selected virtual background image, the composite video feed for transmission to the one or more second electronic devices during the video communication session (block 1022). Then method 1000 ends.

In response to determining that activation is not detected of the control at the one or more input device associated with a recommended virtual background image in decision block 1018, method 1000 includes determining whether the period of time has expired based on the timer (decision block 1024). In response to determining that the period of time has not expired, method 1000 includes waiting for an interval of time (block 1026). Then method 1000 returns to decision block 1018. In response to determining that the period of time has expired, method 1000 includes determining whether a time out setting indicates that the lack of a user action for a period of time to a virtual background image recommendation is to be deemed user implied acquiescence to an automatic change of selected virtual background image (decision block 1028). In response to expiration of the timer, indicating/triggering automatic change based on user implied acquiescence, method 1000 includes changing the selected virtual background image to a recommended virtual background image (block 1030). Then method 1000 returns to block 1022. In response to determining that the time out setting does not indicate that the lack of a user action for a period of time to a virtual background image recommendation is to be deemed user implied acquiescence to an automatic change of the selected virtual background image, method 1000 includes keeping the current VBI, i.e., not changing the selected virtual background image to a recommended virtual background image (block 1032). Then method 1000 returns to block 1022.

According to aspects of the present disclosure, the electronic device 100 (FIG. 1A), method 900 (FIG. 9), method 1000 (FIG. 10), and computer program product, such as RSD 145 (FIG. 1A), provide techniques for presenting a more realistic composite video feed of a user against a virtual background image by triggering a change to a virtual background image illuminated from a direction closely aligned with a direction of illumination of a user image. Among the benefits of the disclosure is that a user is able to present a more realistic and professional appearance by harmonizing the direction of the lighting presented in the video feed with that of the virtual background image.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. An electronic device comprising:
a memory comprising a video communication application (VCA) comprising a plurality of virtual background images, each illuminated by a light source from a respective one of a plurality of different directions;
a communications subsystem that links the electronic device to a communication network; and
a processor communicatively coupled to the memory and the communications subsystem, and which executes the VCA to enable a video communication session between the electronic device and one or more second electronic device, the processor further configured to cause the electronic device to:
detect a virtual background setting of the VCA for the video communication session:
receive a video stream from an image capturing device positioned to capture a user of the electronic device during the video communication session;
determine a beam direction of a lighting source illuminating the user in the video stream;
identify a first virtual background image presenting a background illuminated from a first direction that closely aligns with the beam direction of the lighting source illuminating the user; and
generate and present a composite video feed comprising a foreground image of the video stream superimposed on the first virtual background image, the composite video feed for transmission to the one or more second electronic devices during the video communication session.

2. The electronic device of claim 1, wherein to generate the composite video feed, the processor is configured to cause the electronic device to:
extract a video image of the user from the video stream; and
overlay the video image of the user on the first virtual background image.

3. The electronic device of claim 1, further comprising one or more output devices communicatively coupled to the processor and comprising a display, and wherein the processor is configured to cause the electronic device to:
generate and render, via the display, a video communication session window that comprises the composite video feed.

4. The electronic device of claim 1, wherein the processor is configured to cause the electronic device to:
transmit, via the communications subsystem, the composite video feed to the one or more second electronic devices that are configured to generate and render, via a respective second display, a video communication session window containing the composite video feed.

5. The electronic device of claim 1, further comprising:
one or more output devices communicatively coupled to the processor; and
one or more input device communicatively coupled to the processor and comprising a display, and wherein the processor is configured to cause the electronic device to:
present, via the display, a virtual background selection window containing the first virtual background image and a control feature that enables selection of the first virtual background image by the user via the one or more input device.

6. The electronic device of claim 5, wherein, in presenting, via the display, the virtual background selection window containing the first virtual background image and the control, the processor is configured to cause the electronic device to:
indicate in the virtual background selection window that the first virtual background image has correct lighting; and
indicate in the virtual background selection window that the second virtual background image does not have correct lighting.

7. The electronic device of claim 1, wherein the processor is configured to cause the electronic device to:
periodically determine an updated beam direction of a lighting source illuminating the user in the video stream; and
in response to determining that the updated beam direction has changed from the first direction to a third direction:
identify a third virtual background image presenting a background illuminated from a direction that closely aligns with the third beam direction of the lighting source illuminating the user; and
generate and present a second composite video feed comprising a foreground image of the video stream superimposed on the third virtual background image, the second composite video feed for transmission to the one or more second electronic devices during the video communication session.

8. The electronic device of claim 1, wherein the processor is configured to cause the electronic device to:
in response to determining that a currently selected virtual background image is not the first virtual background image, generate and render a virtual background notification window containing a recommendation for the user to select the first virtual background image.

9. The electronic device of claim 8, wherein the processor is configured to cause the electronic device to:
in response to determining that a change in selection of a currently selected virtual background image has not occurred within a period of time following presentation of the recommendation, change the currently selected virtual background image to the first virtual background image.

10. The electronic device of claim 1, further comprising an artificial intelligence (AI) engine, and wherein the processor is configured to cause the electronic device to determine a lighting direction of one of a background image and of the user in the video feed by using the AI engine trained to determine a lighting direction of an image.

11. The electronic device of claim 1, wherein the plurality of virtual background images comprises the first virtual background image and at least one second virtual background image that is a structurally identical background image to the first virtual background image and has a different light source direction from among the plurality of different directions.

12. A method comprising:
detecting a virtual background setting of a video communication application (VCA) comprising a plurality of virtual background images, each illuminated by a light source from a respective one of a plurality of different directions;
receiving a video stream from an image capturing device positioned to capture a user of an electronic device during a video communication session;
determining a beam direction of a lighting source illuminating the user in the video stream;
identifying a first virtual background image presenting a background illuminated from a first direction that closely aligns with the beam direction of the lighting source illuminating the user; and
generating and presenting a composite video feed comprising a foreground image of the video stream superimposed on the first virtual background image, the composite video feed for transmission to one or more second electronic devices during a video communication session.

13. The method of claim 12, further comprising:
generating the composite video feed by extracting a video image of the user from the video and overlaying the video image of the user on the first virtual background image;
generating and rendering, via a display, a video communication session window that comprises the composite video feed; and
transmitting, via a communications subsystem, the composite video feed to the one or more second electronic devices that are configured to generate and render, via a respective second display, a video communication session window containing the composite video feed.

14. The method of claim 12, further comprising:
presenting, via a display, a virtual background selection window containing the first virtual background image and a control feature that enables selection of the first virtual background image by the user via one or more input device.

15. The method of claim 14, further comprising:
indicating in the virtual background selection window that the first virtual background image has correct lighting; and
indicating in the virtual background selection window that the second virtual background image does not have correct lighting.

16. The method of claim 12, further comprising:
periodically determining an updated beam direction of a lighting source illuminating the user in the video stream; and
in response to determining that the updated beam direction has changed from the first direction to a third direction:
identifying a third virtual background image presenting a background illuminated from a direction that closely aligns with the third beam direction of the lighting source illuminating the user; and
generating and presenting a second composite video feed comprising a foreground image of the video stream superimposed on the third virtual background image, the composite video feed for transmission to the one or more second electronic devices during the video communication session.

17. The method of claim 12, further comprising:
in response to determining that a currently selected virtual background image is not the first virtual background image, generating and rendering a virtual background notification window containing a recommendation for the user to select the first virtual background image; and
in response to determining that a change in selection of a currently selected virtual background image has not occurred within a period of time following presentation of the recommendation, changing the currently selected virtual background image to the first virtual background image.

18. The method of claim 12, further comprising determining a lighting direction of one of a background image and of the user in the video using an artificial intelligence (AI) engine trained to determine a lighting direction of an image.

19. A computer program product comprising:
a computer readable storage device; and
program code on the computer readable storage device that when executed by a processor associated with an electronic device, the program code is configured to cause the electronic device to provide functionality of:
detecting a virtual background setting of a video communication application (VCA) comprising a plurality of virtual background images, each illuminated by a light source from a respective one of a plurality of different directions;
receiving a video stream from an image capturing device positioned to capture a user of the electronic device during a video communication session;
determining a beam direction of a lighting source illuminating the user in the video;
identifying a first virtual background image presenting a background illuminated from a first direction that closely aligns with the beam direction of the lighting source illuminating the user; and
generating and presenting a composite video feed comprising a foreground image of the video stream superimposed on the first virtual background image, the composite video feed for transmission to one or more second electronic devices during a video communication session.

20. The computer program product of claim 19, wherein the program code is further configured to cause the electronic device to provide functionality of:
presenting, via a display, a virtual background selection window containing the first virtual background image and a control feature that enables selection of the first virtual background image by the user via one or more input device;
generating the composite video feed by extracting a video image of the user from the video and overlaying the video image of the user on the first virtual background image;
generating and rendering, via a display, a video communication session window that comprises the composite video feed; and
transmitting, via a communications subsystem, the composite video feed to one or more second electronic devices that are configured to generate and render, via a respective second display, a video communication session window containing the composite video feed.
